(19) United States
(12) Patent Application Publication
(10) Pub. No.: US 2006/0143523 A1
(43) Pub. Date: Jun. 29, 2006

(54) Apparatus and method for debugging embedded software

(75) Inventors: Mingqi You, Beijing (CN); Yong Liu, Beijing (CN)

Correspondence Address: SILICON VALLEY PATENT AGENCY, 7394 WILDFLOWER WAY, CUPERTINO, CA, 95014, US

(73) Assignee: Vimicro Corporation

(21) Appl. No.: 11/317,666

(22) Filed: Dec. 23, 2005

(30) Foreign Application Priority Data
Dec. 24, 2004 (CN) 200410102542.6

(51) Int. Cl. G06F 11/00

(52) U.S. Cl. 714/28

(57) ABSTRACT

Techniques for debugging embedded software are disclosed. According to one aspect of the techniques, debugging embedded software is carried conveniently on an embedded software debugging platform that does not use a traditional emulator. Instead, the platform comprises a computer provided with read/write command functions, a control system of an embedded product to be developed provided with a command interpretation program and read/write command functions, and a communication interface between the computer and the control system of the embedded product for interaction of information and commands.

### BACKGROUND OF THE INVENTION

1. Field of the Invention

The present invention relates to embedded software development, and more particularly to techniques for debugging software to be developed for an embedded product.

2. Description of Related Art

Embedded products have at least the following advantages: having a powerful embedded processor and an essential memory space for running programs; having peripherals for specialized function(s), wherein the embedded processor controls the peripherals by means of reading or writing corresponding registers.

Because the embedded products have such advantages, its development has become an important part of product development. During designing embedded software, it is necessary to frequently debug and revise the embedded software to design specifications. There are mainly two ways to debug the embedded software at present.

One is that the embedded software is debugged by being directly written into an embedded product. The development process is to write the compiled embedded software into the embedded product and constructs the software step by step according to running results of the embedded product. Because the running results may not be immediately demonstrated, this method does not seem to be much helpful.

The other one is that a specialized emulator is provided. This is a method commonly used. However, it is deemed disadvantageous from many standpoints. First, the emulator software is provided by specialized companies, generally such tools need to be paid for and thus increases the development cost. Second, this development method is fairly simplistic and lack of sufficient support of auxiliary tools, which can seriously affect the development speed. Additionally, because the software emulator is configured for the embedded processor, it may not be optimized for the embedded product as a whole.

Thus there is a need for techniques for efficiently debugging the embedded software.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, techniques for efficiently debugging the embedded software are disclosed. According to one aspect of the techniques, debugging embedded software is carried conveniently on an embedded software debugging platform that does not use a traditional emulator, instead the platform comprises a computer provided with read/write command functions, a control system of an embedded product to be developed provided with a command interpretation program and read/write command functions, a communication interface between the computer and the control system of the embedded product for interaction of information and commands.

The present invention may be implemented as a method, a process, and an apparatus. According to one embodiment, the present invention is a method for debugging embedded software on an embedded software debugging platform that includes a computer provided with read/write command functions, a control system of an embedded product to be developed provided with a command interpretation program and read/write command functions, a communication interface between the computer and the control system of the embedded product for interaction of information and commands. The method comprises running the embedded software in the computer, calling the read/write command functions in the computer to send reading/writing register commands to the control system of the embedded product via the communication interface, interpreting the reading/writing register commands by the command interpretation program in the embedded product, and calling corresponding read/write command functions in the embedded product according to the interpreting result to operate peripheral equipments of the embedded product.

Objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIGS. 1a and 1b show respectively two flowcharts, each showing how a piece of embedded software in an embedded product executes;

FIG. 2 is a block diagram or process for debugging embedded software according to one embodiment of the present invention; and

FIG. 3 is a flowchart showing a process of command interpretation operation in one embodiment of the present invention.

### DETAILED DESCRIPTION OF THE INVENTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams or the use of sequence numbers representing one or more embodiments of the invention do not inherently indicate any particular order nor imply any limitations in the invention.

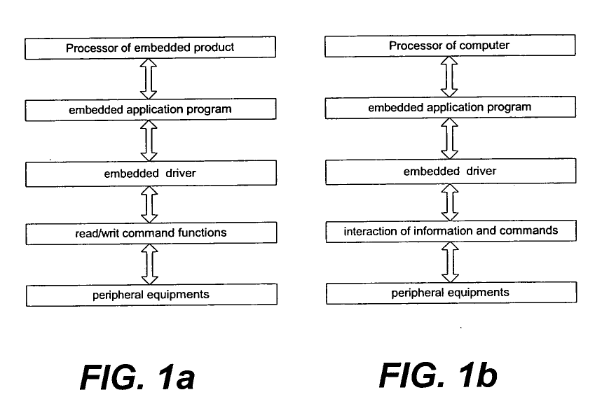

FIG. 1a shows a running process of an embedded software on a control system of an embedded product, which is listed as following: starting an application program and driver by an embedded processor; executing basic read/write operations to corresponding registers of peripheral equipments with help of basic read/writs command functions; and controlling operation of the peripheral equipments of the embedded product according to the corresponding registers.

FIG. 1b shows a running process of the embedded software controlling by a computer, which is listed as following: starting application program and driver by CPU of the computer; constructing interaction of information and commands via a communication interface between the computer and the embedded product, thereby controlling operation of the peripheral equipments of the embedded product.

Comparing the two flowcharts shown in FIGS. 1a and 1b, it can be observed that the embedded software (including the application program and driver) running in the embedded product is substantially similar to that running in the computer. Hence, the method for debugging the embedded software can be completely realized by resources of a computer.

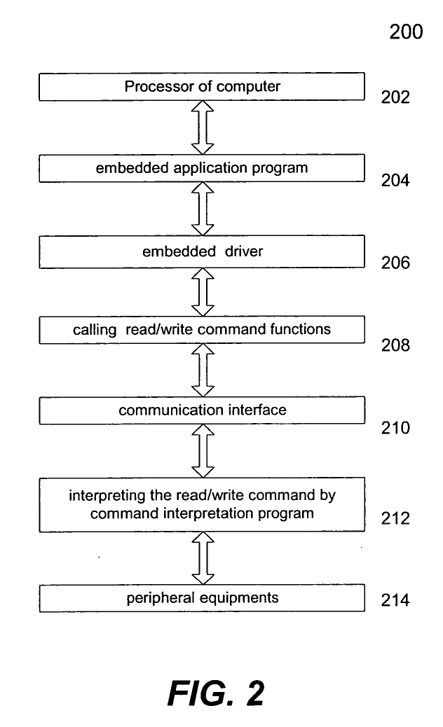

Referring to FIG. 2, which is a block diagram or process 200 of debugging embedded software, according to one embodiment of the present invention. In general, a software debugging platform must be firstly established, which comprises constructing two command functions in a computer, configuring a command interpretation program in the control system of an embedded product to be developed, establishing a communication interface between the computer and the control system for interaction of information and commands.

One of the two command functions is a read command function and the other is a write command function. For example: the write command function is: void Sim_SetReg(int adr, int val), which is responsible for sending a writing register command SetReg(adr, val) to the embedded product, and the read command function is: void Sim_GetReg(int ad, int *val), which is responsible for sending the reading register command GetReg(adr) to the embedded product as well as receiving a feedback result from the embedded product.

The command interpretation program in the control system of the embedded product is responsible for determining that the received command from the computer is the reading register command or the writing register command.

The communication interface is built up by connecting a communication port of the control system with an input/output port of the computer. Additionally, a communication protocol is created for the communication interface. For example, a serial communication interface can be adopted between the computer and control system of the embedded product; the communication protocol may be predefined, such as the TCP/IP communication protocol or a communication protocol defined by a user (e.g., a communication mode based on string).

After the software debugging platform is established, the following operations are executed; inputting the software code for the embedded product into the computer, compiling the software code by a compiler in the computer, running the compiled software in the computer; sending the reading/writing register commands by calling the read/write command functions in the computer into the control system of the embedded product via the communication interface, interpreting the reading/writing register command by the command interpretation program in the embedded product, executing reading/writing operation for corresponding registers according to the reading/writing register command, and controlling the operations of the peripheral equipments of the embedded product according to corresponding registers.

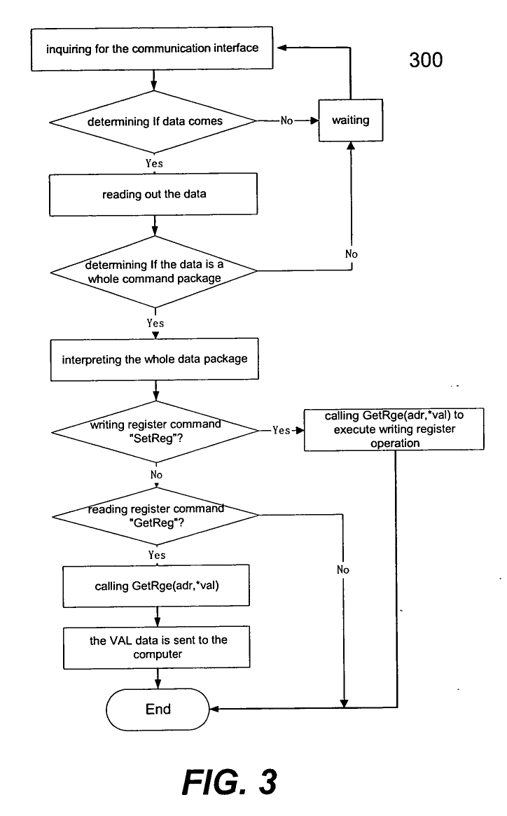

In order to fully understand the present invention, the command interpretation operation 300 is illustrated in FIG. 3. The control system of the embedded product inquires for the communication interface, and then determines whether new data comes. If YES, it reads data from the communication interface; otherwise, it keeps waiting.

According to the predefined communication protocol, the control system determines whether the received data is a whole command package. If YES, it interprets the whole data package; otherwise, it keeps waiting until a whole command package is received. According to the interpretation result, the control system determines whether the command is the writing register command “SetReg”. If YES, a write register function SetReg(adr,val) in the control system is called to execute a writing operation for corresponding register, then the command interpretation process exists. Otherwise, the control system determines whether the command is the reading register command “GetReg”.

If YES, a read register function GetRge(adr,*val) in the control system is called to execute reading operation for corresponding register, where data in VAL is sent to the computer via the communication interface. Then, the command interpretation process exists.

According to the result of read/write operations for corresponding registers, the control system of the embedded product controls the operation of corresponding peripherals, and then conducts an analysis based on the result of the operation of the embedded products. If errors occur, it is needed to revise the software code to be developed and compile and debug it again. If everything goes well, the software code debugging ends. The application program as well as driver which have been debugged in the computer can be loaded into the embedded product.

As described above, the reading/writing function can be one which reads/writes a register or functions for other operation such as reading/writing a buffer. An exemplary format of the command is:

void Sim_WriteBuf(adr, *buf, len);

void Sim_ReadBuf(adr, *buf, len).

The present invention provides techniques for efficiently debugging embedded software on an embedded software debugging platform without using an emulator. The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

What is claimed is:

1. A method for debugging embedded software on an embedded software debugging platform that includes a computer provided with read/write command functions, a control system of an embedded product to be developed provided with a command interpretation program and read/write command functions, a communication interface between the computer and the control system of the embedded product for interaction of information and commands, the method comprising:
running the embedded software in the computer;
calling the read/write command functions in the computer to send reading/writing register commands to the control system of the embedded product via the communication interface;
interpreting the reading/writing register commands by the command interpretation program in the embedded product; and
calling corresponding read/write command functions in the embedded product according to the interpreting result to operate peripheral equipments of the embedded product.

2. The method as claimed in claim 1, wherein, before the running of the embedded software, the following operation performs:
inputting software code for the embedded product into the computer;
compiling the software code by a compiler in the computer into the embedded software.

3. The method as claimed in claim 1, wherein the calling of the read/write command functions is to execute reading/writing operations for corresponding registers of the embedded product according to the reading/writing register commands.

4. The method as claimed in claim 1, further conducting an analysis based on an operation result of the peripherals of the embedded product, if any error occurs, revising the embedded software in accordance with the errors.

5. An apparatus for debugging embedded software, the apparatus comprising:
a computer provided with read/write command functions and running the embedded software;
an embedded product provided with a control system configured with a command interpretation program and read/write command functions;
a communication interface between the computer and the control system of the embedded product for interaction of information and commands, wherein the computer calls the read/write command functions to send reading/writing register commands to the control system of the embedded product via the communication interface, the command interpretation program interprets the reading/writing register commands and the control system calls corresponding read/write command functions in the embedded product according to the interpreting result to operate peripheral equipments of the embedded product.

6. The apparatus as claimed in claim 5, wherein the computer is configured to receive software code for the embedded product and compile the software code by a compiler in the computer into the embedded software.

7. The apparatus as claimed in claim 6, wherein the read/write command functions are to execute reading/writing operations for corresponding registers of the embedded product according to the reading/writing register commands.

8. The apparatus as claimed in claim 5, wherein the computer is configured to demonstrate an operation result of the peripherals of the embedded product, if any error occurs, the embedded software is revised in accordance with the errors.
